(19) United States
(12) Patent Application Publication
(10) Pub. No.: US 2026/0204053 A1
(43) Pub. Date: Jul. 16, 2026

(54) METHOD FOR DATA PROCESSING, METHOD FOR IMAGE CLASSIFICATION, AND RELATED DEVICE

(71) Applicant: MASHANG CONSUMER FINANCE CO., LTD., Chongqing (CN)

(72) Inventor: Yejiang ZHOU, Chongqing (CN)

(21) Appl. No.: 19/297,573

(22) Filed: Aug. 12, 2025

(30) Foreign Application Priority Data
Jan. 15, 2025 (CN) 202510065290.6

(51) Int. Cl. G06V 10/82; G06V 10/77; G06V 10/774

(52) U.S. Cl. CPC G06V 10/82; G06V 10/7715; G06V 10/774

(57) ABSTRACT

A method for data processing, a method for image classification, and related device are provided. The method includes: a sample in an image set is encoded, and an encoding result is mapped to obtain feature information of the sample; a first text feature vector is generated based on the feature information and a first descriptive text of the sample, and a second text feature vector is generated based on the feature information, a second descriptive text of the sample and a class encoding of the sample; an image encoding of the sample is generated based on the first text feature vector, the second text feature vector and the sample, the image encoding including the feature information and class information of the sample; and a parameter of a model is adjusted based on the first text feature vector, the second text feature vector and the image encoding.

### CROSS-REFERENCE TO RELEVANT APPLICATION

The disclosure claims priority to Chinese patent application No. 202510065290.6, filed on Jan. 15, 2025, the contents of which are hereby incorporated by reference in its entirety.

### TECHNICAL FIELD

The present disclosure relates to the field of artificial intelligence technologies, and more particularly to a method for data processing, a method for image classification and a related device.

### BACKGROUND

A core idea of a contrastive language-image pre-training (CLIP) model is to establish a mapping relationship between text and images by jointly encoding text information and image information using pre-training techniques. Specifically, the CLIP model firstly encodes an input image to extract corresponding image features, and then encodes an input text to extract corresponding text features. Next, the CLIP model takes pairs of image features and text features which correspond to each other as positive samples, takes image features and text features which do not correspond as negative samples, and performing training through contrastive learning. However, when dealing with data that are significantly different from the training data, capabilities of the CLIP model are limited, resulting in poor classification results.

### SUMMARY

Embodiments of the present disclosure provides a method for data processing, a method for image classification, and a related device, which may improve a classification effect of a model.

The technical solutions of the embodiments of the present disclosure are implemented as follows.

An embodiment of the present disclosure provides a method for data processing, which includes the following operations.

A sample in an image set is encoded, and an encoding result is mapped to obtain feature information of the sample.

A first text feature vector is generated based on the feature information and a first descriptive text of the sample, and a second text feature vector is generated based on the feature information, a second descriptive text of the sample and a class encoding of the sample.

An image encoding of the sample is generated based on the first text feature vector, the second text feature vector and the sample. The image encoding includes the feature information and class information of the sample.

A parameter of a model is adjusted based on the first text feature vector, the second text feature vector and the image encoding.

An embodiment of the present disclosure provides a method for image classification, which includes the following operations.

An image to be classified is acquired.

The image to be classified is classified by a pre-trained model to obtain a classification result. The pre-trained model is trained according to the method for data processing provided by the embodiments of the present disclosure.

An embodiment of the present disclosure provides a data processing apparatus, which includes an encoding module, a first generation module, a second generation module, and a training module.

The encoding module is configured to encode a sample in an image set, and map an encoding result to obtain feature information of the sample.

The first generation module is configured to generate a first text feature vector based on the feature information and a first descriptive text of the sample, and generate a second text feature vector based on the feature information, a second descriptive text of the sample and a class encoding of the sample.

The second generation module is configured to generate an image encoding of the sample based on the first text feature vector, the second text feature vector and the sample. The image encoding includes the feature information and class information of the sample.

The training module is configured to adjust a parameter of a model based on the first text feature vector, the second text feature vector and the image encoding.

An embodiment of the present disclosure provides an image classification apparatus, which includes an acquiring module and a classification module.

The acquiring module is configured to acquire an image to be classified.

The classification module is configured to classify the image to be classified by a pre-trained model to obtain a classification result. The pre-trained model is trained according to the method for data processing provided by the embodiments of the present disclosure.

An embodiment of the present disclosure provides an electronic device, which includes a memory and a processor.

The memory is configured to store computer-executable instructions.

The processor is configured to execute the computer-executable instructions stored in the memory, to implement the method for data processing or the method for image classification provided by the embodiments of the present disclosure.

An embodiment of the present disclosure provides a computer-readable storage medium. The computer-readable storage medium is configured to store a computer program or computer-executable instructions. The computer program or the computer-executable instructions, when executed by a processor, implement the method for data processing or the method for image classification provided by the embodiments of the present disclosure.

An embodiment of the present disclosure provides a computer program product.

The computer program product includes a computer program or computer-executable instructions. The computer program or the computer-executable instructions, when executed by a processor, implement the method for data processing or the method for image classification provided by the embodiments of the present disclosure is implemented.

The embodiments of the present disclosure have the following beneficial effects.

The first text feature vector is obtained by combining the first descriptive text and the feature information of the sample, so that the first text feature vector fuses information from two different perspectives of the image and the text; and the second text feature vector is obtained by combining the second descriptive text, the class encoding, and the feature information of the sample, so that the second text feature vector not only fuses the information from the two different perspectives of the image and the text, but also fuses the class information. Then, the image encoding is generated based on the first text feature vector, the second text feature vector and the sample. The image encoding not only reflects the features from the two different perspectives of the image and the text, but also reflects the difference between the first text feature vector and the second text feature vector (that is, the first text feature vector does not fuse the class information, while the second text feature vector fuses the class information), so that the model can not only learn an association between the class and the information from the two different perspectives of the image and the text, but also learn an association with the class from a perspective of the difference between the first text feature vector and the second text feature vector. In this way, the classification result is more accurate and reliable, thereby improving classification performance of the model.

### BRIEF DESCRIPTION OF THE DRAWINGS

FIG. 1 is a schematic diagram illustrating an architecture of a data processing system 10 according to an embodiment of the present disclosure.

FIG. 2A is a schematic diagram illustrating a structure of an electronic device 400 for data processing according to an embodiment of the present disclosure.

FIG. 2B is a schematic diagram illustrating a structure of an electronic device 500 for image classification according to an embodiment of the present disclosure.

FIG. 3 is a first flowchart illustrating a method for data processing according to an embodiment of the present disclosure.

FIG. 4 is a second flowchart illustrating a method for data processing according to an embodiment of the present disclosure.

FIG. 5 is a third flowchart illustrating a method for data processing according to an embodiment of the present disclosure.

FIG. 6 is fourth flowchart illustrating a method for data processing according to an embodiment of the present disclosure.

FIG. 7 is a fifth flowchart illustrating a method for data processing according to an embodiment of the present disclosure.

FIG. 8 is a sixth flowchart illustrating a method for data processing according to an embodiment of the present disclosure.

FIG. 9 is a first flowchart illustrating a method for image classification according to an embodiment of the present disclosure.

FIG. 10 is second flowchart illustrating a method for image classification according to an embodiment of the present disclosure.

FIG. 11 is a schematic diagram illustrating a principle of a method for data processing according to an embodiment of the present disclosure.

It should be noted that “first” and “second” mentioned above are only used to distinguish different solutions and do not represent superiority or inferiority of the solutions or their priorities during an implementation process.

### DETAILED DESCRIPTION

To make the objectives, technical solutions and advantages of the present disclosure clearer, a further detailed description of the present disclosure will be provided below in combination with the accompanying drawings. The embodiments described should not be regarded as limitations to the present disclosure. All other embodiments obtained by an ordinary skilled person in the art without creative effort fall within the scope of protection of the present disclosure.

In the following description, the expression “some embodiments” describes a subset of all possible embodiments. However, it should be understood that “some embodiments” may be a same subset or different subsets of all possible embodiments and may be combined with each other without conflict.

The term “first/second/third” involved in the following description is merely used to distinguish similar objects and does not represent a particular ordering of objects. It should be understood that “first/second/third” may be interchanged in a particular order or sequence, so that the embodiments of the present disclosure described herein can be implemented in an order other than that illustrated or described herein.

In the embodiments of the present disclosure, the term “module” or “unit” refers to a computer program with a predefined function or a part of the computer program, which works with other related parts to achieve a predefined goal and can be implemented in whole or in part by using software, hardware (such as a processing circuit or memory), or a combination thereof. Similarly, one processor (or multiple processors or memories) may be configured to implement one or more modules or units. In addition, each module or unit can be a part of an overall module or unit that includes the functions of the module or unit.

Unless otherwise defined, all technical and scientific terms used in the embodiments of the present disclosure have the same meaning as that commonly understood by those skilled in the art. The terms used herein are merely intended to describe the embodiments of the present disclosure and are not intended to limit the present disclosure.

During example application of the relevant data collection and processing in the embodiments of the present disclosure, the informed consent or individual consent of a personal information subject needs to be obtained in strict accordance with the requirements of relevant laws and regulations, and the subsequent data use and processing behavior is carried out within the scope of authorization of laws and regulations and the personal information subject.

Before the embodiments of the present disclosure are further described in detail, a description is made on nouns and terms in the embodiments of the present disclosure, and the nouns and terms in the embodiments of the present disclosure are applicable to the following explanations.

1) Feature information: It is also referred to as domain information and may refer to a feature vector obtained after an image is encoded by an image encoder. Feature information represents characteristics and properties of the image in a specific domain, which may include color information, text information, background information, style information, or the like. The specific domain is also referred to an implicit space in which the feature vector is located. For example, in a simple sketch image of a puppy on the grass, its feature information may include the color information corresponding to an image color, the text information, the background information corresponding to “the grass”, and the style information corresponding to the “simple sketch” of the image in the specific domain.

2) Stable diffusion (SD): It is a type of generative model based on a diffusion process. The diffusion process is a random process that describes evolution of a system's state over time and is widely used in fields such as physics, chemistry, and biology. In the generative model, the diffusion process is used to gradually transform simple random noise into complex high-dimensional data such as an image, a text, and audio. The SD can transform a natural language description into a high-quality image, for example, given a text description “a black cat standing on the grass”, the SD can generate an image of a realistic cat standing on the grass.

3) Positive prompt (PP): It is a prompt that guides the SD to generate an image with specific content. For example, the given text description “a black cat standing on the grass” is the PP.

4) Negative prompt (NP): It is a prompt that excludes unwanted elements and guides the SD to generate an image that does not contain the specific content. For example, an image generated by the SD will not include an element of “car” based on the NP “car”.

5) Upsampling: It is a technique used to increase spatial resolution or a size of a feature map in an output of a model, for example, it can be used to map an encoded vector to a dimension that is the same as the size of the image.

The related art proposes a new method for zero-shot out-of-distribution (OOD) detection using a contrastive language-image pre-training (CLIP) model. This method does not require training on a known in-distribution (ID) dataset with data in the same distribution as training data, but adds negative logic to the text by introducing a learnable “no” prompt to assist in detection. However, the method has the following problems: model performance drops significantly for the samples that are very different from the training data, and scalability is not high.

In view of this, the embodiments of the present disclosure provide a method for data processing, a method for image classification, devices, an electronic device, a computer-readable storage medium and a computer program product, which may improve a classification effect of a model. The electronic device provided by the embodiments of the present disclosure is described below. The electronic device provided by the embodiments of the present disclosure may be implemented as various types of terminals including a laptop, a tablet, a desktop computer, a set-top box, a smart phone, a smart speaker, a smart watch, a smart television, a vehicle-mounted terminal, or the like. The electronic device provided by the embodiments of the present disclosure may also be implemented as a server, or implemented through collaboration of the terminal and the server.

For example, referring to FIG. 1, FIG. 1 is a schematic diagram illustrating an architecture of a data processing system 10 according to an embodiment of the present disclosure. To support an application that can improve the classification effect of the model, in the data processing system 10, a terminal 100 is connected to a server 200 via a network 300. The network 300 may be a wide area network, a local area network, or a combination of the wide area network and the local area network.

The server 200 is configured to: encode a sample (image sample, picture sample) in the image set and map the encoding result to obtain feature information of the sample; generate a first text feature vector based on the feature information and a first descriptive text of the sample, and generate a second text feature vector based on the feature information, a second descriptive text of the sample and a class encoding of the sample; generate an image encoding of the sample based on the first text feature vector, the second text feature vector and the sample, the image encoding includes the feature information and class information of the sample; and adjust a parameter of a model based on the first text feature vector, the second text feature vector and the image encoding.

The server 200 is further configured to send a trained model to the terminal 100, so that the terminal 100 performs image classification based on the trained model.

The terminal 100 is also configured to acquire images to be classified, and classify the images by a pre-trained model to obtain a classification result.

In some embodiments, the server 200 may be an independent physical server, or may be a server cluster or distributed system including a plurality of physical servers, or a cloud server that provides basic cloud computing services such as a cloud service, a cloud database, cloud computing, a cloud function, a cloud storage, a network service, cloud communication, a middleware service, a domain name service, a content delivery network (CDN), a big data and artificial intelligence platform, or the like. The terminal and the server may be directly or indirectly connected through wired or wireless communication, which is not limited by the embodiments of the present disclosure.

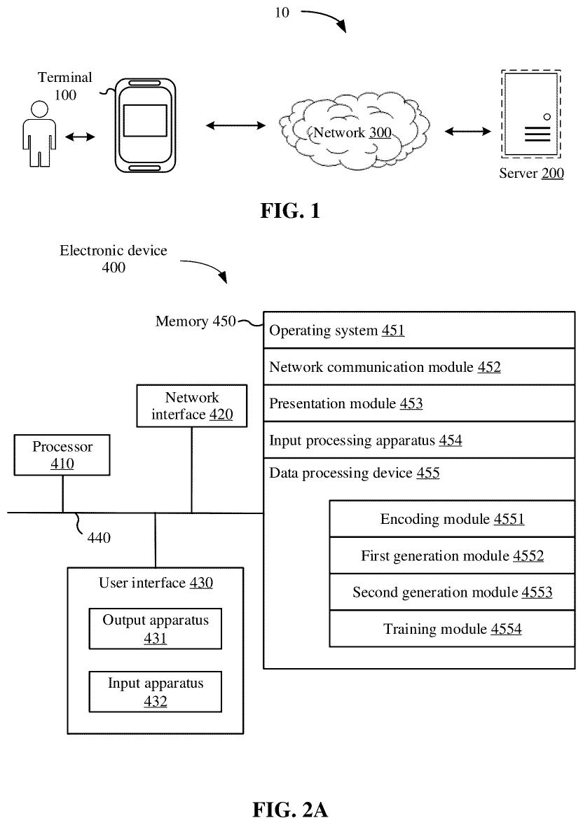

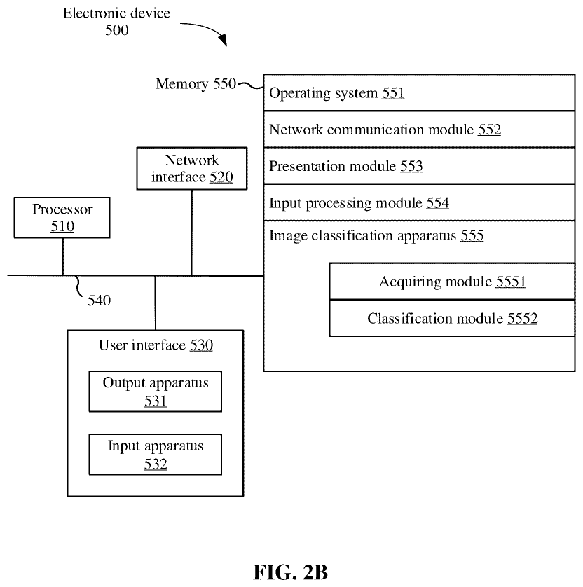

Referring to FIG. 2A, FIG. 2A is a schematic diagram illustrating a structure of an electronic device 400 for data processing according to an embodiment of the present disclosure. The electronic device 400 illustrated in FIG. 2A includes: at least one processor 410, a memory 450, at least one network interface 420 and a user interface 430. The components of the electronic device 400 are coupled together through a bus system 440. It should be understood that the bus system 440 is configured to implement communication connection among these components. In addition to a data bus, the bus system 440 further includes a power bus, a control bus, and a status signal bus. However, for the sake of clarity, all types of buses are labeled as the bus system 440 in FIG. 2A.

The processor 410 may be an integrated circuit chip that has a capability for processing signals, such as a general-purpose processor, a digital signal processor (DSP), or another programmable logical device, a discrete gate or transistor logical device, a discrete hardware component or the like. The general-purpose processor may be a microprocessor or any conventional processor and the like.

The user interface 430 includes one or more output apparatuses 431 that enable presentation of media content, including one or more speakers and/or one or more visual display screens. The user interface 430 further includes one or more input apparatuses 432, including a user interface component that facilitates inputting of a user, such as a keyboard, a mouse, a microphone, a touchscreen display, a camera, other input buttons and controls.

The memory 450 may be a removable memory, a non-removable memory, or a combination thereof. An exemplary hardware device includes a solid-state memory, a hard disk drive, an optical disc drive, and the like. The memory 450 optionally includes one or more storage devices physically located away from the processor 410.

The memory 450 includes a volatile memory or a non-volatile memory, or may include both a volatile memory and a non-volatile memory. The non-volatile memory may be a read-only memory (ROM), and the volatile memory may be a random access memory (RAM). The memory 450 described in the embodiments of the present disclosure is intended to include any suitable type of memory.

In some embodiments, the memory 450 is capable of storing data to support various operations. Examples of the data include a program, a module, and a data structure or a subset or superset thereof, which are described below by using examples.

An operating system 451 includes system programs for processing various basic system services and performing hardware-related tasks, such as a framework layer, a core library layer, and a driver layer, and is used for implementing various basic services and processing hardware-based tasks. A network communication module 452 is configured to reach other electronic devices via one or more (wired or wireless) network interfaces 420. Exemplarily, the network interfaces 420 include Bluetooth, wireless fidelity (WiFi), a universal serial bus (USB), and the like. A presentation module 453 is configured to present information via one or more output apparatuses 431 (such as a display screen and a speaker) associated with the user interface 430 (for example, a user interface for operating a peripheral device and displaying content and information). An input processing module 454 is configured to detect one or more user inputs or interaction from one of the one or more input apparatuses 432 and translate the detected inputs or interaction.

In some embodiments, the data processing apparatus provided by the embodiments of the present disclosure may be implemented in a software manner. FIG. 2A illustrates a data processing apparatus 455 stored in the memory 450, which may be software in a form of a program or a plugin, including the following software modules: an encoding module 4551, a first generation module 4552, a second generation module 4553 and a training module 4554. These modules are logical and thus may be combined or further divided arbitrarily according to functions to be implemented. Functions of each module will be described below.

The electronic device for implementing the method for image classification provided in the embodiments of the present disclosure will be described below. Referring to FIG. 2B, FIG. 2B is a schematic diagram illustrating a structure of an electronic device 500 for image classification according to an embodiment of the present disclosure. The electronic device 500 illustrated in FIG. 2B includes: at least one processor 510, a memory 550, at least one network interface 520, and a user interface 530. The components of the electronic device 500 are coupled together through a bus system 540. The user interface 530 includes an output apparatus 531, and an input apparatus 532. The memory 550 includes: an operating system 551, a network communication module 552, a presentation module 553 and an input processing module 554. It should be noted that functions of the components in FIG. 2B are similar to those of the components in FIG. 2A.

In some embodiments, the image classification apparatus provided by the embodiments of the present disclosure may be implemented in a software manner. FIG. 2B illustrates an image classification apparatus 555 stored in the memory 550, which may be software in a form of a program or a plugin, including the following software modules: an acquiring module 5551 and a classification module 5552. These modules are logical and thus may be combined or further divided arbitrarily according to functions to be implemented. Functions of each module will be described below.

In some other embodiments, the data processing apparatus or the image classification apparatus provided by the embodiments of the present disclosure may be implemented in a hardware manner. In an example, the data processing apparatus or image classification apparatus provided by the embodiments of the present disclosure may be a processor in a form of a hardware decoding processor, which is programmed to perform the method for data processing provided by the embodiments of the present disclosure. For example, the processor in the form of the hardware decoding processor may adopt one or more application specific integrated circuits (ASICs), digital signal processors (DSP), programmable logic devices (PLDs), complex programmable logic devices (CPLDs), field-programmable gate arrays (FPGAs), or other electronic components.

The method for data processing provided by the embodiments of the present disclosure will be described below in conjunction with an example application and implementation of the electronic device provided by the embodiments of the present disclosure. The method for data processing provided by the embodiments of the present disclosure will be described by taking a server as an execution subject.

Referring to FIG. 3, FIG. 3 is a first flowchart illustrating a method for data processing according to an embodiment of the present disclosure. The following describes the method with reference to the operations in 101 to 105 illustrated in FIG. 3.

In 101, a sample in an image set is encoded, and an encoding result is mapped to obtain feature information of the sample.

The image set (denoted as D) includes a first sample (denoted as D_{close}) and a second sample (denoted as Dₒₚₑₙ).

In some embodiments, a sample (denoted as x) may be randomly selected from the image set. The sample is encoded through an image encoder (denoted as Fᵥ) to obtain the encoding result of the sample. The encoding result is mapped through a first linear mapping layer (denoted as F_{do}) to obtain feature information of the sample. The feature information refers to information included in an implicit spatial domain in which the sample is located, which may be simply regarded as a mean μ and a variance σ represented by the sample. That is, the feature information is an implicit representation expressed using (μ, σ). During a model training process, each sample in the image set can obtain respective feature information corresponding to the sample by referring to the above implementation.

For example, a convolutional neural network (CNN) may include a convolutional layer (i.e., the image encoder) and a fully connected layer (i.e., the first linear mapping layer). The convolutional layer may be used to extract a feature of the image, output a feature vector, and deliver the feature vector to the fully connected layer. In the fully connected layer, the mean and variance of the feature vector may be calculated (achieved by applying mathematical operations on the feature vector. For example, the mean and variance of each element of the feature vector may be calculated, or the mean and variance of the whole feature vector may be calculated).

It should be noted that the feature information corresponding to the same sample can include first feature information and second feature information. Specifically, the sample can be encoded through the image encoder to obtain the encoding result of the sample, and the encoding result can be mapped through the first linear mapping layer, and a perturbation can be randomly added during the mapping process so as to obtain the first feature information. Since the perturbation is randomly added, the second feature information different from the first feature information can be obtained by repeating the above implementation. According to the operation in 101, the feature information is the implicit representation using (μ, σ). A method for randomly adding the perturbation may involve increasing or decreasing the variance σ with a range of increase or decrease being within 10%, which is not limited by the embodiments of the present disclosure.

Text descriptions of the same sample may also be different and may include a first descriptive text and a second descriptive text. The first descriptive text and the second descriptive text are encoded through a text encoder to obtain a first descriptive text encoding and a second descriptive text encoding. For example, a sample of “a black cat standing on the grass” may have multiple descriptive texts such as “a black cat standing on the grass”, “there is a black cat on the grass”, “there is a black cat standing on the grass”, and the like. Different descriptive text encodings can be obtained by encoding the multiple descriptive texts of the sample. The encoding process may involve converting each word into a unique numeric identifier, and then combining these numeric identifiers into a vector. The vector can capture a core feature of the text and largely reflect main content of the sample. However, due to the different descriptive ways and perspectives of descriptive texts, the resulting encoded vectors will also vary, which is like viewing a painting from different perspectives, with each perspective presenting different features and details. Therefore, a series of different descriptive text encodings can be obtained by encoding multiple descriptive texts of the sample, and theses encodings collectively constitute rich semantic information of the sample. In practical applications, these descriptive text encodings can be used in fields such as image classification, image retrieval, computer vision. For example, in an image classification task, a class to which an image belongs can be determined by comparing descriptive text encoding of the image with encodings of known classes. In an image retrieval task, an image similar to a query image can be found by comparing descriptive text encoding of the query image with encodings of images in a database. In computer vision research, the descriptive text encoding may help a model better understand and interpret image content.

In 102, a first text feature vector is generated based on the feature information and a first descriptive text of the sample.

The feature information includes first feature information and second feature information.

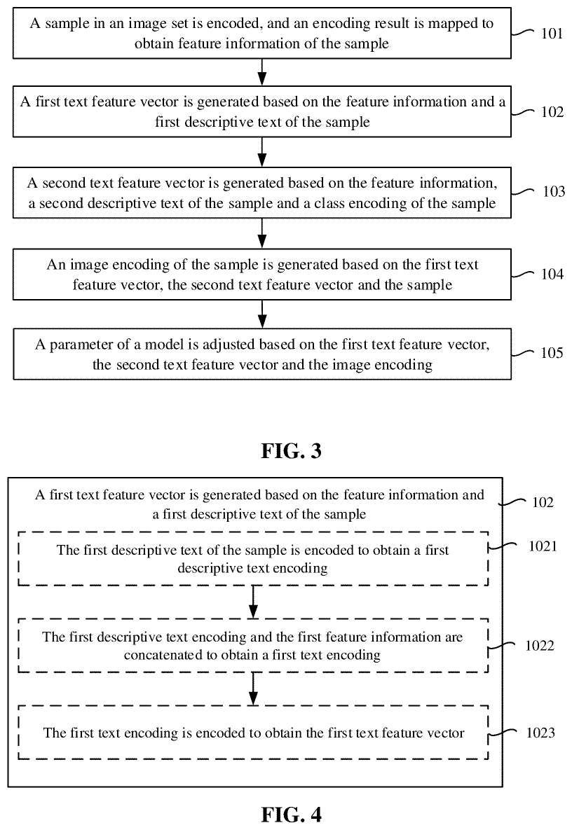

In some embodiments, referring to FIG. 4, FIG. 4 is a second flowchart illustrating a method for data processing according to an embodiment of the present disclosure. The operation in 102 illustrated in FIG. 3 may be implemented through operations in 1021 to 1023 as described below.

In 1021, the first descriptive text of the sample is encoded to obtain a first descriptive text encoding.

In some embodiments, the first descriptive text is encoded separately by the text encoder to obtain the first descriptive text encoding. The text encoder may be a tool for converting the text into a digital vector, and different text encoders have different encoding methods, which are not limited by the present disclosure. The text encoder can be selected according to the actual application.

The text encoder typically first segments the text and then converts each of segmentation results into a corresponding vector. For example, the sentence “a black cat standing on the grass” is segmented into [“a”, “black”, “cat”, “standing”, “on”, “the”, “grass”] and encoded with the text encoder, then each segmented result may correspond to an encoded vector. Finally, the text encoder outputs an encoded vector corresponding to the entire sentence, which is often used to represent the meaning of the entire sentence.

In 1022, the first descriptive text encoding and the first feature information are concatenated to obtain a first text encoding.

In some embodiments, the concatenation may be performed in the order of the first feature information and the first descriptive text encoding (assumed to be denoted as w₁ . . . wₙ), and the obtained concatenation result is used as the first text encoding (assumed to be denoted as t₁). The concatenation may also be performed in the order of the first feature information, the first descriptive text encoding, and a class encoding (where the class encoding is set to zero), thereby obtaining the first text encoding.

In 1023, the first text encoding is encoded to obtain the first text feature vector.

In some embodiments, the first text encoding is encoded separately by the text encoder to obtain the first text feature vector. Specifically, the first text encoding obtained through concatenation is taken as a complete text, and the first text encoding may be encoded with reference to the implementation in 1021 to obtain the first text feature vector, which will not be repeated here.

Through the operations in 1021 to 1023, the first text feature vector can be obtained by combining the first feature information and the first descriptive text of the sample, so that the first text feature vector fuses information from two different perspectives of the image and the text. In this way, the model can capture visual information and semantic information of the sample more comprehensively, thereby improving accuracy of model classification.

With continued reference to FIG. 3, the description following the operation in 102 mentioned above is provided.

In 103, a second text feature vector is generated based on the feature information, a second descriptive text of the sample and a class encoding of the sample.

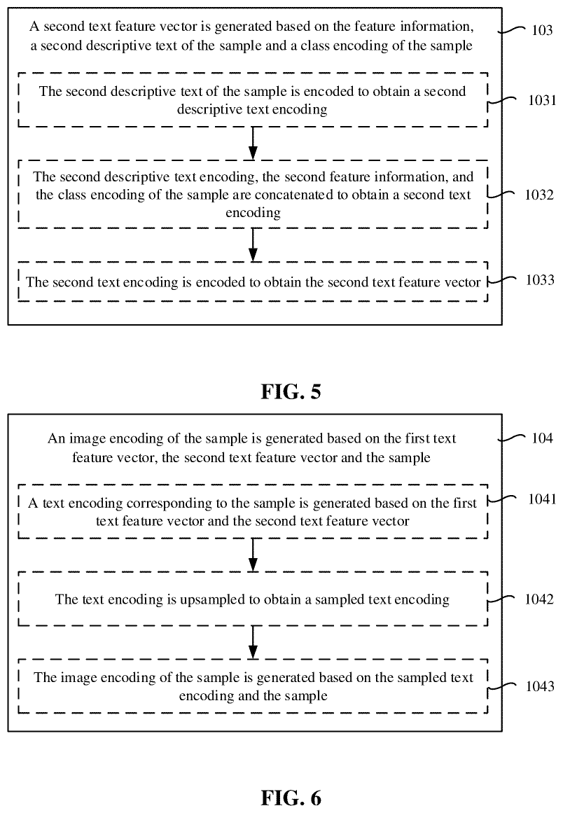

In some embodiments, referring to FIG. 5, FIG. 5 is a third flowchart illustrating a method for data processing according to an embodiment of the present disclosure. The operation in 103 illustrated in FIG. 3 may be implemented through operations in 1031 to 1033 as described below.

The class encoding is obtained by encoding class information of a class to which the sample belongs.

In 1031, the second descriptive text of the sample is encoded to obtain a second descriptive text encoding.

In some embodiments, the second descriptive text encoding may be obtained by referring to the implementation in 1021, which will not be repeated here.

In 1032, the second descriptive text encoding, the second feature information and the class encoding of the sample are concatenated to obtain a second text encoding.

In some embodiments, the concatenation may be performed in the order of the second feature information, the second descriptive text encoding (assumed to be denoted as v₁ . . . vₙ), and the class encoding, and the obtained concatenation result is used as the second text encoding (assumed to be denoted as t₂). The class encoding is obtained by encoding the class information of the class to which the sample belongs.

In 1033, the second text encoding is encoded to obtain the second text feature vector.

In some embodiments, the second text feature vector may be obtained by referring to the implementation in 1023, which will not be repeated here.

In some embodiments, the first text encoding and the second text encoding are encoded respectively by the text encoder to obtain the first text feature vector and the second text feature vector.

Through the operations in 1031 to 1033, the second text feature vector can be obtained by combining the feature information, the second descriptive text, and the class encoding of the sample, so that the second text feature vector not only fuses information from two different perspectives of the image and the text, but also fuses the class information. Multimodal fusion can enhance an expressive capability of the features, so that the model can capture visual information, semantic information and class information of the sample more comprehensively, thereby improving the accuracy of the model classification.

With continued reference to FIG. 3, the description following the operation in 103 mentioned above is provided.

In 104, an image encoding of the sample is generated based on the first text feature vector, the second text feature vector and the sample.

The image encoding includes the feature information and class information of the sample.

In some embodiments, referring to FIG. 6, FIG. 6 is fourth flowchart illustrating a method for data processing according to an embodiment of the present disclosure. The operation in 104 illustrated in FIG. 3 may be implemented through operations in 1041 to 1043 as described below.

In 1041, a text encoding corresponding to the sample is generated based on the first text feature vector and the second text feature vector.

The text encoding includes the feature information and the class information of the sample.

In some embodiments, subtraction between the second text feature vector and the first text feature vector is performed, and in the subtraction process, the subtraction should be performed based on the concatenation order used when obtaining the text encoding, so as to obtain the text encoding that includes the feature information and the class information.

In 1042, the text encoding is upsampled to obtain a sampled text encoding.

The dimension of the sampled text encoding is the same as that of the sample.

In some embodiments, the text encoding is upsampled through an upsampling network (assumed to be denoted as Fᵤₚ) based on the dimension of the sample to obtain the sampled text encoding, so that the dimension of the sampled text encoding is the same as that of the sample. To achieve a deep fusion of the sample and the text, the text encoding may be dimensionally aligned with the sample. The text encoding may be upsampled through the upsampling network, so that the dimension of the sampled text encoding is the same as that of the sample. The upsampling network is a network structure that enlarges the dimension of the text encoding. The dimension of the text encoding is gradually increased by upsampling an original text encoding layer by layer. The process can be regarded as mapping the original text encoding from a low-dimensional space to a high-dimensional space.

The original text encoding is typically a fixed-dimension vector, for example, the original text encoding may be a 768-dimensional word vector. The sample is typically high-dimensional, for example, a sample may be a pixel matrix with a dimension of 256*256. To make the text encoding have the same dimension as the sample, the text encoding may be upsampled through the upsampling network. After upsampling, the dimension of the text encoding becomes the same as that of the image encoding, for example, both are the dimension of 256*256. The upsampling network can be structured in various ways, such as a convolutional neural network, a recurrent neural network, or the like. In practical applications, the appropriate upsampling network structure can be selected based on requirements of a specific task. By upsampling the text encoding through the upsampling network, the dimension of the sampled text encoding can be the same as that of the sample. In this way, the text encoding may be directly compared or fused with the sample.

In 1043, the image encoding of the sample is generated based on the sampled text encoding and the sample.

In some embodiments, the above operation in 1043 may be achieved by: adding the sampled text encoding and the sample to obtain an addition result and mapping the addition result to obtain a mapping result, and encoding the mapping result to obtain the image encoding of the sample.

In an example, the sampled text encoding is added to the sample to obtain the addition result, and the addition result is mapped through a second linear mapping layer (assumed to be denoted as Fₚᵣₒⱼ) to obtain the mapping result, and then the mapping result is encoded through the image encoder to obtain the image encoding including the feature information and the class information of the sample.

The sampled text encoding, which has the same dimension as the sample, is added to the sample. After the addition result is obtained, the addition result is mapped through the second linear mapping layer. The linear mapping layer can map the vector from the high-dimensional space to the low-dimensional space, which helps the model better process and interpret the fused information. The mapping layer may be a fully connected layer, and a weight of the mapping layer may be learned through training. The purpose of the operation is to further compress and adjust the fused information to make the fused information more suitable for subsequent encoding and processing operations.

The mapping result is a vector in the low-dimensional space, and the dimension of the vector is usually less than that of the original image. The low-dimensional vector includes fusion information of the text and the image, which includes the feature information and the class information. The mapping result is encoded by the image encoder to obtain the image encoding including the feature information and the class information of the sample. The image encoder may be a convolutional neural network, which may recognize and extract a local feature and a global feature from the image. During this process, the mapping result is encoded into a high-dimensional image representation for image classification, object detection, or other computer vision tasks. The entire fusion process not only keeps the visual information of the image but also fuses the semantic information of the text, thereby enhancing a capability of the model for understanding the content of the image. The fused information can help the model distinguish images of different classes.

Through the above technical solutions, the sampled text encoding and the sample can be added, and the addition result can be mapped to obtain the mapping result, and finally, the mapping result can be encoded to obtain the image encoding of the sample, so that the feature information and the class information of the sample are fused in the image encoding, and the content of the image can be understood by the model more deeply, thus improving classification effect of the model.

Through the operations in 1041 to 1043, the text encoding can be generated based on the first text feature vector and the second text feature vector, so that the text encoding fuses the feature information and the class information. Then, the text encoding is upsampled to make its dimension the same as the dimension of the sample. Finally, the image encoding of the sample is generated based on the sampled text encoding and the sample, so that the feature information and the class information of the sample can be fused in the image encoding, and the content of the image and the content of the text can be understood by the model more deeply, and thus improving classification effect of the model.

With continued reference to FIG. 3, the description following the operation in 104 mentioned above is provided.

In 105, a parameter of a model is adjusted based on the first text feature vector, the second text feature vector and the image encoding.

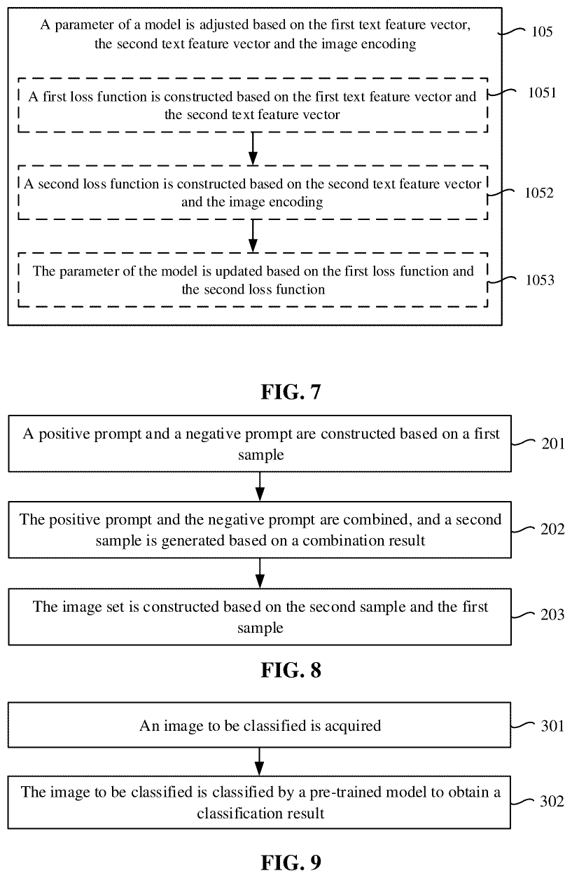

In some embodiments, referring to FIG. 7, FIG. 7 is a fifth flowchart illustrating a method for data processing according to an embodiment of the present disclosure. The operation in 105 illustrated in FIG. 3 may be implemented through operations in 1051 to 1053 as described below.

In 1051, a first loss function is constructed based on the first text feature vector and the second text feature vector.

In some embodiments, the first loss function is used to ensure that samples from different domains but belonging to the same class have consistent semantic information, which helps improve a generalization capability of the model. The first loss function is expressed as follows:

$${L}_{s i m i l arity} = - log ( {E}_{1} , {E}_{2} ) \qquad ( 1 )$$

where L_{similarity} is the first loss function, E₁ is the first text feature vector, and E₂ is the second text feature vector.

The logarithmic distance log(E₁, E₂) between E₁ and E₂ is used to measure dissimilarity between two vectors. The measurement method can convert a distance into a logarithmic space, which makes the loss function easier to optimize. If E₁ and E₂ are very similar, the distance between E₁ and E₂ will be very small, which will result in a very large logarithmic distance, and consequently, a value of the whole loss function will be small. Conversely, if E₁ and E₂ are not similar, the logarithmic distance between E₁ and E₂ will be small, and the value of the whole loss function will be large.

In 1052, a second loss function is constructed based on the second text feature vector and the image encoding.

In some embodiments, the second loss function is used to ensure that the image features learned by the model are consistent with the corresponding feature information and class information, which helps improve a predictive capability of the model. The second loss function is expressed as follows:

$${L}_{c ontrastive} = min ( {E}_{3} , {E}_{4} ) \qquad ( 2 )$$

where L_{contrastive} is the second loss function, E₃ is the second text feature vector, and E₄ is the image encoding.

The min function is used to take a minimum value of two numbers, and min(E₃, E₄) represents the smaller value of E₃ and E₄. L_{contrastive} is an output of the contrastive loss function. If the model can effectively distinguish two samples, there will be a significant difference between E₃ and E₄, and thus min(E₃, E₄) will be close to zero, which indicates that a value of the loss function is small and the model performs well. Conversely, if the model cannot distinguish samples, E₃ will be very close to E₄, and min(E₃, E₄) will be close to the smaller value of E₃ and E₄, which indicates the value of the loss function will be large, and the model needs to be adjusted to improve the distinguishing capability.

The contrastive loss function is particularly useful in self-supervised learning and meta-learning, where there is often no available labeled data to directly guide model's learning. The contrastive loss function helps the model learn how to extract discriminative features from the data, thereby improving performance of the model without labeled data.

In 1053, the parameter of the model is updated based on the first loss function and the second loss function.

In some embodiments, the model (e.g., the image classification model) may include: a text encoder, an image encoder, and a linear mapping layer. The text encoder is configured to generate the first text feature vector and the second text feature vector, the image encoder is configured to encode the sample, and the linear mapping layer is configured to generate the image encoding of the sample. The operation in 1053 can be achieved by constructing a total loss function based on the first loss function and the second loss function, keeping a parameter of the text encoder and a parameter of the image encoder unchanged, and updating a parameter of the linear mapping layer based on the total loss function.

In an example, the model can be trained through the total loss function, and the total loss function is expressed as follows:

$$L = a {L}_{s i m i l arity} + b {L}_{c ontrastive} \qquad ( 3 )$$

where L is the total loss function, L_{similarity} is the first loss function, L_{contrastive} is the second loss function, a is a weight of the first loss function, and b is a weight of the second loss function. It should be noted that the values of the weights can be set according to the actual application. For example, a may be equal to b, a value of a and a value of b are both 0.5. The total loss function enables the model to simultaneously learn how to measure the similarity between vectors and how to distinguish samples of different classes, so that the model can perform better in various data processing tasks.

In an example, before training the model, the parameter of the text encoder and the parameter of the image encoder are fixed to ensure that these parameters keep unchanged during training, and then the parameter of the linear mapping layer is updated based on the total loss function during training. A backpropagation algorithm may be used to calculate a gradient of the total loss function with respect to the parameter of the linear mapping layer respectively. The gradient points to a direction in which the loss function grows fastest, and the backpropagation algorithm updates the parameter in the opposite direction of the gradient. Then, a gradient descent algorithm or other optimization algorithms can be used to update the parameter of the linear mapping layer, and the updated parameter will be used for the next forward propagation to iteratively improve the feature representation capability of the model. It should be noted that the linear mapping layer may include the first linear mapping layer and the second linear mapping layer.

In addition, the model may include the text encoder, the image encoder, the upsampling network, the first linear mapping layer and the second linear mapping layer. The operation in 1053 can be achieved by constructing the total loss function based on the first loss function and the second loss function, keeping the parameter of the text encoder and the parameter of the image encoder unchanged, and updating a parameter of the first linear mapping layer and a parameter of the second mapping layer based on the total loss function. The implementation of parameter updating can refer to the implementation of the above technical solutions, which will not be repeated here.

Through the above technical solutions, the parameter of the text encoder and the parameter of the image encoder can be fixed, so as to effectively constrain the training degrees of freedom of the model, thereby reducing dependence of the model on the training data during the training process, reducing the occurrence of overfitting, and enhancing the generalization capability of the model. The parameter of the first linear mapping layer can be updated, and the updated first linear mapping layer can make the generated feature information more accurate; the parameter of the second linear mapping layer can be updated, and the updated second linear mapping layer can better fuse and understand different features from the text encoding and the sample; the parameter of the upsampling network can also be updated to increase the dimension of the text encoding, enabling the model to obtain richer text features.

Through the operations in 1051 to 1053, the model can be trained based on the first loss function and the second loss function to enhance the predictive capability and the generalization capability of the model.

In some embodiments, referring to FIG. 8, FIG. 8 is a sixth flowchart illustrating a method for data processing according to an embodiment of the present disclosure. An image set may be constructed before the operation in 101 illustrated in FIG. 3, which is described below in conjunction with operations in 201 to 203.

In 201, a positive prompt and a negative prompt are constructed based on a first sample.

In some embodiments, related information of the second sample to be generated (including images of a known class and images of an unknown class) may be determined based on the first sample, and then the corresponding positive prompt and negative prompt are constructed based on this information.

For example, all the images in the first sample are related to animals, images of the classes “cats” and “dogs” account for a relatively large proportion, and the backgrounds of these images are mostly “indoor scenes”. It indicates that the distribution of the first sample is unbalanced, and when the model is trained using these image samples, the classification effect of the model will be reduced. Thus, it may be determined that images of other animals in “outdoor scenes” need to be generated. Then, it may be determined that the constructed positive prompt is “objects in outdoor scenes” and the negative prompt is “cats, dogs”.

For example, in the first sample, images related to “cars” account for a relatively large proportion, and the backgrounds of these images are also mostly “winter scenes”, then it may be determined that images of other objects in “summer scenes” need to be generated. In such case, it may be determined that the constructed positive prompt is “objects in summer scenes” and the negative prompt is “cars”. It is also possible to construct the positive prompt as “objects in spring scenes” and the negative prompt as “cars”, or construct the positive prompt as “objects in autumn scenes” and the negative prompt as “cars”.

For example, in the first sample, images related to “urban scenes” account for a relatively large proportion, and the classes of these images include “trees, flowers, grass”, it may be determined that images including “trees, flowers, grass” except “urban scenes” need to be generated. Then, it may be determined that the constructed positive prompt is “trees, flowers, grass” and the constructed negative prompt is “urban scenes”.

In 202, the positive prompt and the negative prompt are combined, and a second sample is generated based on the combination result.

The second sample includes at least one of: a sample of a known class or a sample of an unknown class.

It should be noted that the known class refers to a class corresponding to the original sample (i.e., the first sample) in the image set, and an unknown class refers to a new class other than the class corresponding to the original sample in the image set. For example, the sample of the known class in the image set may be classified as “cats” or “dogs”, and the sample of the unknown class in the image set may be classified as “cars”. The sample of the known class may be a newly-generated image of an unknown domain but known class, and the sample of the unknown class may be a newly-generated image of a known domain but unknown class.

In some embodiments, the positive prompt and the negative prompt are combined, and the combination result is used as an input of the SD. The SD may generate a new sample (i.e., the second sample) based on the input (input content). For example, the constructed positive prompt is “objects in outdoor scenes” and the constructed negative prompt is “cats, dogs”, and the combination result “objects other than cats and dogs in outdoor scenes” is obtained after combining the positive prompt and the negative prompt; and then, the SD may generate images of unknown classes based on the combination result “objects other than cats and dogs in outdoor scenes”. For example, the constructed positive prompt is “objects in spring scenes” and the constructed negative prompt is “cars”, and the combination result “objects other than cars in spring scenes” is obtained after combining the positive prompt and the negative prompt; and then, the SD may generate images of unknown classes based on the combination result “objects other than cars in spring scenes”. For example, the proportion of images related to “urban scenes” in the first sample is relatively large, and the classes of these images include “trees, flowers, grass”, it may be determined that images including “trees, flowers, grass” except “urban scenes” need to be generated. Then, it may be determined that the constructed positive prompt is “trees, flowers, grass” and the constructed negative prompt is “urban scenes”. The combination result “trees, flowers, grass outside of urban scenes” is obtained after combining the positive prompt and the negative prompt, and the SD may generate images of unknown domain but known classes based on the combination result “trees, flowers, grass outside of urban scenes”.

In some embodiments, multiple second samples are generated. After generating the multiple second samples based on the combination result, the following processing may be performed: adjusting the positive prompt and the negative prompt, and/or removing samples with a quality parameter less than a quality parameter threshold from the multiple second samples.

In an example, in a process of generating the second sample, multiple second samples are generated. Since the class of a newly-generated sample is random, there may be a case in which objects of a certain class are generated in a large number. In this case, the positive prompt and negative prompt may be adjusted based the class of the already generated second samples. For example, the majority of the second samples generated based on the combination result “objects other than cats and dogs in outdoor scenes” are images of “rabbits”. In order to generate images of other objects, the negative prompt may be adjusted from “cats, dogs” to “cats, dogs, rabbits”. Alternatively, the majority of the generated second samples are images of “urban scenes”, in order to generate images in other scenes, the positive prompt may be adjusted from “objects in outdoor scenes” to “objects in rural scenes”. For example, the majority of the second samples generated based on the combination result “objects other than cars in spring scenes” are images of “trees”. In order to generate images of other objects, the negative prompt may be adjusted from “car” to “trees”. Alternatively, the majority of the scenes in the generated second samples are images of “spring scenes”, in order to generate images in other scenes and make the samples more balanced, the positive prompt may be adjusted from “objects in spring scenes” to “objects in autumn scenes”.

In an example, in the process of generating the second sample, multiple second samples are generated with different sample quality, and there may be samples with poor quality. In this case, samples with quality parameters less than the quality parameter threshold may be deleted from the second samples. For example, based on an entropy of a grayscale image, an image with a lower entropy may be filtered out. The entropy of the grayscale image is an indicator that measures richness and complexity of image information. The larger entropy indicates that there is more information in the image and the distribution is more uniform. The entropy of the grayscale image typically ranges from 0 and 8, with 8 being an upper limit for information completeness. An entropy close to 8 usually means that grayscale distribution of the image is very uniform and contains a large amount of information; while an entropy close to 0 usually means that grayscale distribution of the image is very concentrated and may contain little information or no useful information. A threshold of the entropy of the grayscale image can be set according to the actual application, which is not limited by the embodiments of the present disclosure.

In 203, the image set is constructed based on the second sample and the first sample.

In some embodiments, firstly, each new image is labeled based on the class information of the new image to form the second sample. Then, the union of the second sample and the first sample is taken to construct the image set. It should be noted that when the class of the new sample is different from the class of the first sample, this class is an unknown class. However, after labeling the new images and taking the union of the second sample(s) and the first sample(s) to construct the image set, the unknown class(es) will become known. Additionally, if one second sample has the same domain and the same class as one first sample, then the second sample will be removed.

Through the operations in 201 to 203, the positive prompt and the negative prompt may be adjusted to quickly generate sample data in other domains, enriching the samples in the image set and thereby improving classification performance of the trained model.

The method for image classification provided by the embodiments of the present disclosure will be described in combination with an example application and implementation of the electronic device provided by the embodiments of the present disclosure. The method for image classification provided by the embodiments of the present disclosure will be described below by taking a terminal as an execution subject.

Referring to FIG. 9, FIG. 9 is a first flowchart illustrating a method for image classification according to an embodiment of the present disclosure. The following describes the method with reference to the operations in 301 to 302 illustrated in FIG. 9.

In 301, an image to be classified is acquired.

In some embodiments, feature information included in the image to be classified may be feature information not included in training data samples (i.e., the image set), or class information included in the image to be classified may be class information not included in the training data samples.

In 302, the image is classified by a pre-trained model to obtain a classification result.

The pre-trained model is obtained according to the method for data processing.

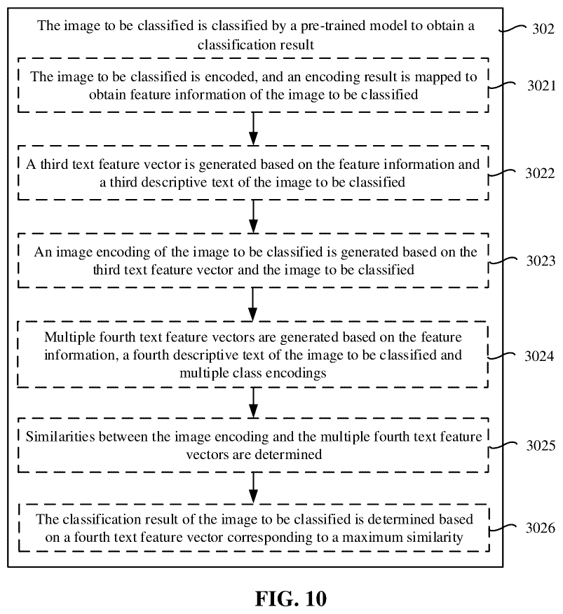

In some embodiments, referring to FIG. 10, FIG. 10 is second flowchart illustrating a method for image classification according to an embodiment of the present disclosure. The operation in 302 illustrated in FIG. 9 may be implemented through operations in 3021 to 3026 as described below.

The operation in 3021 to 3026 may be performed through the pre-trained model.

In 3021, the image to be classified is encoded, and the encoding result is mapped to obtain feature information of the image to be classified.

In some embodiments, after the image to be classified is obtained, the implementation in 101 may be referred to obtain the feature information of the image to be classified, which will not be repeated here.

In 3022, a third text feature vector is generated based on the feature information and a third descriptive text of the image to be classified.

In some embodiments, the third descriptive text is a descriptive text of the image to be classified, and the third descriptive text of the image to be classified is encoded to obtain a third descriptive text encoding. The implementation of obtaining the third descriptive text encoding may be referred to the operation in 1021, which will not be repeated here. The third descriptive text encoding is concatenated with the feature information to obtain the third text feature vector. The implementation of obtaining the third text feature vector may be referred to the operations in 1022-1023, which will not be repeated here.

In 3023, an image encoding of the image to be classified is generated based on the third text feature vector and the image to be classified.

The image encoding includes the feature information.

In some embodiments, the third text feature vector is upsampled to obtain a sampled text encoding. The dimension of the sampled text encoding is the same as that of the image to be classified. The sampled text encoding is added to the image to be classified to obtain an addition result, and the addition result is mapped to obtain a mapping result. The mapping result is encoded to obtain the image encoding including the feature information.

In 3024, multiple fourth text feature vectors are generated based on the feature information, a fourth descriptive text of the image to be classified, and multiple class encodings.

The multiple class encodings are obtained by encoding class information of a first class and class information of a second class. The first class is a class of a sample in the image set, and the first class is different from the second class.

In some embodiments, the feature information may be obtained by mapping the image encoding through a first linear mapping layer, and a perturbation may also be randomly added during the mapping process to obtain different feature information. Then, the multiple fourth descriptive texts may be obtained. The fourth descriptive texts may be text titles, text descriptions or the like extracted from large-scale text datasets, or grabbed from web pages. Each fourth descriptive text corresponds to one class. The multiple fourth descriptive texts of the image to be classified are encoded to obtain multiple fourth descriptive text encodings. Then, the first class and the second class are encoded through the text encoder to obtain multiple class encodings. The first class is a class of an image in the image set (including a class corresponding to the first sample and a class corresponding to the second sample). The first class is different from the second class (the second class may be an unknown class set according to the actual application, and the unknown class herein is different from the class of the image in the image set). The multiple fourth text encodings are obtained by concatenating in the order of the feature information, the fourth descriptive text encodings, and the class encodings. Then, the multiple fourth text encodings are encoded respectively by a text encoder to obtain the multiple fourth text feature vectors.

In 3025, similarities between the image encoding and the multiple fourth text feature vectors are determined.

In some embodiments, a distance between the image encoding and each of the multiple fourth text feature vectors is calculated. The closer the distance, the greater the similarity between the image encoding and the text feature vector.

In 3026, the classification result of the image to be classified is determined based on a fourth text feature vector corresponding to a maximum similarity.

In some embodiments, a fourth text feature vector with a shortest distance (i.e., the fourth text feature vector corresponding to the maximum similarity) is determined based on distances between the image encoding and the multiple fourth text feature vectors. The class information is determined based on a class encoding in the fourth text feature vector, and a class corresponding to the obtained class information is used as the classification result of the image to be classified.

Through the operations in 3021 to 3026, the similarities between the image encoding and the text feature vectors can be calculated, so as to achieve the fusion of information between the image and the text, thereby improving the classification effect of the model. In addition, by adding the class encoding for the unknown class, the model can also have a capability for processing the unknown class.

Through the embodiments of the present disclosure, the first text feature vector is obtained by combining the feature information of the sample and the first descriptive text, so that the first text feature vector fuses information from two different perspectives of the image and the text; and the second text feature vector is obtained by combining the feature information of the sample, the second descriptive text and the class encoding, so that the second text feature vector not only fuses information from two different perspectives of the image and the text, but also fuses the class information. Then, the image encoding is generated based on the first text feature vector, the second text feature vector and the sample. The image encoding not only reflects the features from two different perspectives of the image and the text, but also reflects the difference between the first text feature vector and the second text feature vector (that is, the first text feature vector does not fuse the class information, while the second text feature vector fuses the class information), so that the model can not only learn an association between the class and the information from the two different perspectives of the image and the text, but also learn an association with the class from a perspective of the difference between the first text feature vector and the second text feature vector. In this way, the classification result is more accurate and reliable, thus improving classification performance of the model.

An exemplary application of the embodiments of the present disclosure in a practical application scenario will be described below.

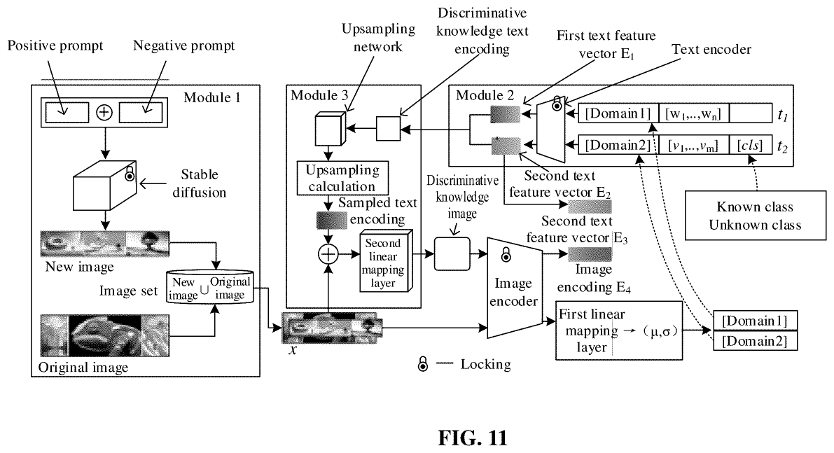

Referring to FIG. 11, FIG. 11 is a schematic diagram illustrating a principle of a method for data processing according to an embodiment of the present disclosure. It can be seen from the contents in FIG. 11 that the training algorithm framework of the model provided by the embodiments of the present disclosure includes three modules (Module 1, Module 2 and Module 3). The model may be an image classification model. Module 1 represents pseudo-open set image generation, which is configured to generate new images outside of the known class(es) (i.e., samples of the unknown class(es)). Module 2 is domain class prompt generation, which is configured to generate text encoding with a domain (the domain can be any information in the image other than the class information) and class information. Module 3 is visual encoding generation with discriminative knowledge, which is configured to generate a visual encoding with the domain (i.e., the feature information) and the class information. The locking identifier indicates that the parameters keep unchanged during training and the parameters of the pre-trained model are directly used. The SD may generate new images (i.e., images including images of the known class(es) and images of the unknown class(es)) Dₒₚₑₙ (i.e., the second sample) based on the prompt obtained from the combination of the PP and the NP. The original image is represented as D_{close} (i.e., the first sample), and the union of Dₒₚₑₙ and D_{close} forms all the images (i.e., the image set) D for training, which includes the known class(es) and other classes (i.e., classes other than the known classes in D). x represents one of the images in the image set D. Parameters of the SD, the image encoder (Fᵥ) and the text encoder (Fₜ) keep unchanged during training.

The training algorithm framework for the image classification model provided in the embodiments of the present disclosure includes three modules as follows.

### Module 1: Pseudo-Open Image Set Generation

The PP may be defined as “a [source domain] of an unknown class”, that is, a prompt of an unknown class (the domain is known), and the NP may be defined as “a list of known classes” (i.e., names of n known classes). When a combination of the PP and the NP is input in the Stable Diffusion (SD), one or more new images of the unknown classes may be generated. The PP is the positive prompt that guides to generation of images with specific content, and the NP is a negative prompt that excludes unwanted elements. The combination of the PP and the NP can control the content of the generated image more precisely (e.g., a certain element is excluded). In a process of generating new images, the PP and the NP need to be constantly adjusted. The joint use of the PP and the NP aims to generate other images that are semantically different from the existing classes but still conform the original image domain (such as style, background). For example, if the PP is “a [sketch] of an unknown class”, the NP may be “person, cats, cars”, and the sketch is a style feature of an image, an image in the sketch style of an object that has not been explicitly classified or identified is generated, and the image does include three classes of person, cats, cars. In this way, diversity of the generated image is ensured, while low-quality images may be filtered out (using the method based on the entropy of the grayscale image, in which the lower the entropy, the worse the image quality). If images in D_{close} do not meet training requirements or the number of images that meet the training requirements is insufficient, Dₒₚₑₙ can be generated through the module 1.

### Module 2: Discriminative Knowledge Text Encoding Generation

Inputs of Module 2 include two parts: a text encoding t₁ (i.e., the first text encoding) and a text encoding t₂ (i.e., the second text encoding). t₁ includes three parts, i.e., Domain1 (i.e., the first feature information), a direct encoding of the text w₁ . . . wₙ (i.e., a text encoding of a text description of an image, the first descriptive text encoding), and 0 (corresponding to cls of t₂, but with 0 as the placeholder). t₂ includes three parts, i.e., Domain2 (i.e., the second feature information), a direct encoding of the text v₁ . . . vₘ (i.e., a text encoding of a text description of an image, the second descriptive text encoding), and a class encoding cls (which may be an class in the set D, a known class refers to a class corresponding to an image of a known class in the image set, an unknown class refer to a class corresponding to an image of an unknown class in the image set, that is, the class encoding cls is the class encoding of the sample). The three parts may be concatenated directly. Domain knowledge (i.e., the feature information) refers to an implicit spatial domain in which the image is located. The domain knowledge is from the image x (i.e. the sample/image sample), the image x is encoded by Fᵥ to obtain the image encoding, and then the image encoding is mapped through a linear layer F_{do} (i.e. the first linear mapping layer) to an implicit representation of an image domain, which may be simply regarded as the mean μ and the variance σ of the image representation. The domain knowledge is an implicit representation expressed using (μ, σ). The text encoding t and the class encoding cls are obtained directly using the text encoder. The difference between t₁ and t₂ is that class encoding cls of t₁ needs to be set to zero, while the calculation method for the domain knowledge is the same (domain is an image representation calculated from F_{do}, and when the domain is generated, a small random perturbation is added to make the two domain knowledge (i.e. Domain1 and Domain2) slightly different, the method for adding a random perturbation may be based on the mean μ and the variance σ, such as increasing or decreasing the variance a within a range of 10%), but the domain knowledge needs to be recalculated once. Then t₁ and t₂ pass through the text encoder Fₜ to obtain the first text feature vector E₁ and the second text feature vector E₂ (E₂ equals to E₃). The calculation of the final discriminative knowledge text encoding E(diff,t) is expressed as follows:

$$E ( diff , t ) = {E}_{2} ⊖ {E}_{1} \qquad ( 4 )$$

E(diff,t) is the discriminative knowledge text encoding (i.e., text encoding including the feature information and the class information), E₁ is the first text feature vector, E₂ is the second text feature vector, and θ represents element-wise subtraction between two feature vectors (i.e., elements at corresponding positions of the two feature vectors are subtracted).

Since Module 2 introduces the domain knowledge and the class information, the obtained E(diff,t) (which can also be expressed as \hat{x}) is a text encoding with the discriminative knowledge (including the domain knowledge and the class information).

### Module 3: Discriminative Knowledge Image Encoding Generation

After the discriminative knowledge text encoding \hat{x} is obtained, \hat{x} is fed into the upsampling network Fᵤₚ. Fᵤₚ is used to map a encoding vector to a dimension that is same as a dimension of an input image. That is, the sampled text encoding e₁, which is the same size as the image, is obtained through one upsampling calculation Fᵤₚ(\hat{x}). The sampled text encoding e₁ is added elementwise to the image x, so that the image also has the discriminative knowledge. The discriminative knowledge herein is from the domain and the class. Then a discriminative knowledge image \tilde{x} is obtained through a linear mapping structure Fₚⱼᵣₒ (i.e., the second linear mapping layer). \tilde{x} is encoded by the image encoder Fᵥ to obtain the image encoding E₄ of the discriminative knowledge image.

The core of Module 2 and Module 3 is that the text encoding and the image encoding carry the discriminatory knowledge, which helps the model perceive data of other classes, thereby achieving domain generalization.

There are two loss functions in the embodiments of the present disclosure. The first one is the first loss function, which may be the loss function expressed as the above formula (1). The loss function ensures that images from different domains but belonging to the same class have consistent semantic information, which helps to improve the generalization capability of the model.

The second one is the second loss function, which may be the loss function expressed as the above formula (2). The loss function ensures that the image features learned by the model are aligned with the corresponding domain and class information, thereby improving the predictive capability of the model.

The total loss function is expressed as follows:

$$L = {L}_{s i m i l a r i t y} + {L}_{c ontrastive} \qquad ( 5 )$$

L is the total loss function, L_{similarity} is the first loss function, and L_{contrastive} is the second loss function. The formula (5) is considered as the formula (3) with the weights of 1 (i.e., a=1, b=1)

It should be noted that during the training of the image classification model, the parameters of the image encoder, the text encoder and the SD with the lock identifiers keep unchanged, and the parameters of other structures are updated.

In the embodiments of the present disclosure, the text encoding and the image encoding carry the discriminatory knowledge, which helps the model perceive data of other classes, thereby achieving domain generalization.

After the image classification model is trained, any image of another domain, along with the domain information and text information of the image may be input. The image passes through an image encoding branch to obtain E₄, and the text passes through a text encoding branch to obtain E₃. Only distances between E₃ and E₄ need to be calculated, a cls of E₃, which is closest to E₄, may be used as the class corresponding to the image.

Firstly, the visual encoding is obtained by encoding through Fᵥ, and then the visual encoding is mapped through the linear layer F_{do} to the implicit representation of the image domain (i.e., Domain). t₃ is obtained based on the Domain and the descriptive text of the image, and t₃ is fed into the upsampling network Fᵤₚ, to obtain the text encoding having a size same as the image through one calculation Fᵤₚ(\hat{x}). The text encoding is added elementwise to the image. The addition result passes through Fₚᵣₒⱼ to obtain the image including the Domain. The image passes through the image encoder Fᵥ to obtain the image encoding E₄ including the Domain (there is only one E₄). Multiple t₄ are obtained based on the multiple text description information of the image, the Domain, the class corresponding to the image in the D, and candidate classes (predefined possible classes of the image). The multiple t₄ pass through the text encoding branch to obtain multiple E₂ (i.e., E₃). Only the distances between each E₃ and the E₄ need to be calculated, and the cls of E₃, which is closest to E₄, is used as the class corresponding to the image.

The ultimate purpose of training the image classification model is to classify images from other domains correctly.

The following continues to describe an example structure in which a data processing apparatus 455 provided by the embodiments of the present disclosure is implemented as software modules. In some embodiments, as illustrated in FIG. 2A, the software modules in the data processing apparatus 455 stored in the memory 450 may include an encoding module 4551, a first generation module 4552, a second generation module 4553, and a training module 4554.

The encoding module 4551 is configured to encode a sample in an image set, and map an encoding result to obtain feature information of the sample. The first generation module 4552 is configured to generate a first text feature vector based on the feature information and a first descriptive text of the sample, and generate a second text feature vector based on the feature information, a second descriptive text of the sample and a class encoding of the sample. The second generation module 4553 is configured to generate an image encoding of the sample based on the first text feature vector, the second text feature vector and the sample. The image encoding includes the feature information and class information of the sample. The training module 4554 is configured to adjust a parameter of a model based on the first text feature vector, the second text feature vector and the image encoding.

In some embodiments, the apparatus also includes a constructing module and a combination module.

The constructing module is configured to construct a positive prompt and a negative prompt based on a first sample. The combination module is configured to combine the positive prompt and the negative prompt, and generate a second sample(s) based on the combination result. The second sample includes at least one of: a sample of a known class or a sample of an unknown class. The constructing module is further configured to construct the image set based on the second sample and the first sample.

In some embodiments, the feature information includes first feature information and second feature information. The first generation module 4552 is further configured to encode the first descriptive text of the sample to obtain a first descriptive text encoding, concatenate the first descriptive text encoding and the first feature information to obtain a first text encoding, and encode the first text encoding to obtain the first text feature vector. The first generation module 4552 is further configured to encode the second descriptive text of the sample to obtain a second descriptive text encoding, concatenate the second descriptive text encoding, the second feature information and the class encoding of the sample to obtain a second text encoding, and encode the second text encoding to obtain the second text feature vector.

In some embodiments, the second generation module 4553 is further configured to generate a text encoding corresponding to the sample based on the first text feature vector and the second text feature vector. The text encoding includes the feature information and the class information of the sample. The second generation module 4553 is further configured to upsample the text encoding to obtain a sampled text encoding. A dimension of the sampled text encoding is the same as a dimension of the sample. The second generation module 4553 is further configured to generate the image encoding of the sample based on the sampled text encoding and the sample.

In some embodiments, the second generation module 4553 is further configured to add the sampled text encoding and the sample and map an addition result to obtain a mapping result, and encode the mapping result to obtain the image encoding of the sample.

In some embodiments, the training module 4554 further configured to construct a first loss function based on the first text feature vector and the second text feature vector, construct a second loss function based on the second text feature vector and the image encoding, and update the parameter of the model based on the first loss function and the second loss function.

In some embodiments, the model includes: a text encoder, an image encoder, and a linear mapping layer. The text encoder is configured to generate the first text feature vector and the second text feature vector, the image encoder is configured to encode the sample, and the linear mapping layer is configured to generate the image encoding of the sample. The training module 4554 is configured to construct a total loss function based on the first loss function and the second loss function, keep a parameter of the text encoder and a parameter of the image encoder unchanged, and update a parameter of the linear mapping layer based on the total loss function.

The following continues to describe an example structure in which an image classification apparatus 555 provided by the embodiments of the present disclosure is implemented as software modules. In some embodiments, as illustrated in FIG. 2B, the software modules in the image classification apparatus 555 stored in the memory 550 may include an acquiring module 5551 and a classification module 5552.

The acquiring module 5551 is configured to acquire an image to be classified. The classification module is configured to classify the image to be classified by a pre-trained model to obtain a classification result. The pre-trained model is trained according to the method for data processing.

In some embodiments, the classification module 5552 is further configured to perform the following processing through the pre-trained model: encoding the image to be classified and mapping an encoding result to obtain feature information of the image to be classified; generating a third text feature vector based on the feature information and a third descriptive text of the image to be classified; generating an image encoding of the image to be classified based on the third text feature vector and the image to be classified, where the image encoding includes the feature information; generate multiple fourth text feature vectors based on the feature information, a fourth descriptive text of the image to be classified and multiple class encodings, where the multiple class encodings are obtained by encoding class information of a first class and class information of a second class, the first class is a class of a sample in an image set and the first class is different from the second class; determining similarities between the image encoding and the multiple fourth text feature vectors; and determining the classification result of the image to be classified based on a fourth text feature vector corresponding to a maximum similarity.

An embodiment of the present disclosure provides a computer program product. The computer program product includes a computer program or computer-executable instructions. The computer program or the computer-executable instructions are stored in a computer-readable storage medium. A processor of an electronic device reads the computer-executable instructions from the computer-readable storage medium, and the processor executes the computer-executable instructions, to cause the electronic device to implement the method for data processing or the method for image classification described in the embodiments of the present disclosure.

An embodiment of the present disclosure provides a computer-readable storage medium having sored computer-executable instructions or a computer program therein. The computer program or the computer-executable instructions, when executed by a processor, cause the processor to implement the method for data processing provided by the embodiments of the present disclosure, such as the method for data processing illustrated in any of FIG. 3 to FIG. 8, or the method for image classification illustrated in any of FIG. 9 to FIG. 10.

In some embodiments, the computer-readable storage medium may be a memory such as a random access memory (RAM), a read-only memory (ROM), a flash memory, a magnetic surface memory, an optical disk, or a compact disc read-only memory (CD-ROM), or may be various devices including one or any combination of the above-mentioned memories.

In some embodiments, the computer-executable instructions may be written in a form of a program, software, a software module, a script, or code in any form of programming language (including compiled or interpretive language, or declarative or procedural language), and the computer-executable instructions may be deployed in any form, including being deployed as an independent program or being deployed as a module, component, subroutine, or another unit suitable for use in a computing environment.

In an example, the computer-executable instructions may but may not necessarily correspond to a file in a file system, and may be stored in apart of the file for storing other programs or data, for example, stored in one or more scripts in a hyper text markup language (HTML) document, stored in a single file specially for the discussed program, or stored in a plurality of collaborative files (for example, files storing one or more modules, a subroutine, or a code part).

In an example, the computer-executable instructions may be deployed to be executed on one electronic device, or on a plurality of electronic devices located at one location, or on a plurality of electronic devices distributed at a plurality of locations and connected by a communication network.

In summary, the first text feature vector is obtained by combining the feature information of the sample and the first descriptive text, so that the first text feature vector fuses information from two different perspectives of the image and the text; and the second text feature vector is obtained by combining the feature information of the sample, the second descriptive text and the class encoding, so that the second text feature vector not only fuses the information from the two different perspectives of the image and the text, but also fuses the class information. Then, the image encoding is generated based on the first text feature vector, the second text feature vector and the sample. The image encoding not only reflects the features from the two different perspectives of the image and the text, but also reflects the difference between the first text feature vector and the second text feature vector (that is, the first text feature vector does not fuse the class information, while the second text feature vector fuses the class information), so that the model can not only learn an association between the class and the information from the two different perspectives of the image and the text, but also learn an association with the class from a perspective of the difference between the first text feature vector and the second text feature vector, thereby making the classification result more accurate and reliable, and thus improving classification performance of the model. The first text feature vector can be obtained by combining the first feature information and the first descriptive text of the sample, so that the first text feature vector fuses information from two different perspectives of the image and the text. In this way, the model can capture visual information and semantic information of the sample more comprehensively, thereby improving accuracy of model classification. The second text feature vector can be obtained by combining the feature information of the sample, the second descriptive text, and the class encoding, so that the second text feature vector not only fuses the information from two different perspectives of the image and the text, but also fuses the class information. Multimodal fusion can enhance expressive capability of the features, so that the model can more comprehensively capture the visual information, semantic information and class information of the sample, thereby improving the accuracy of the model classification. The text encoding is generated based on the first text feature vector and the second text feature vector, so that the text encoding fuses the feature information and the class information. Then, the text encoding is upsampled to make its dimension the same as the dimension of the sample. Finally, the image encoding of the sample is generated based on the sampled text encoding and the sample, so that the feature information and the class information of the sample can be fused in the image encoding, and the content of the image and the content of the text can be understood by the model more deeply, and thus improving classification effect of the model. The parameter of the text encoder and the parameter of the image encoder can be fixed, so as to effectively constrain the training degrees of freedom of the model, thereby reducing dependence of the model on the training data during the training process, reducing the occurrence of overfitting, and enhancing the generalization capability of the model. The parameter of the first linear mapping layer can be updated, and the updated first linear mapping layer can make the generated feature information more accurate; the parameter of the second linear mapping layer can be updated, and the updated second linear mapping layer can better fuse and understand different features from the text encoding and the sample; the parameter of the upsampling network can also be updated to increase the dimension of the text encoding, enabling the model to obtain richer text features. The model can be trained based on the first loss function and the second loss function to enhance the predictive capability and generalization capability of the model. The positive prompt and the negative prompt may be adjusted to quickly generate sample data in other domains, enriching the samples in the image set and thereby improving classification performance of the trained model. The similarities between the image encoding and the text feature vectors can be calculated, and the fusion of information between the image and the text is achieved, thereby improving the classification effect of the model, and further, by adding the class encoding for the unknown class, the model can also have a capability for processing the unknown class. The text encoding can perceive the discriminative knowledge by introducing the feature information, the class information or the like and by optimizing the encoding similarities. The image encoding can perceive the discriminative knowledge by embedding the discriminative knowledge text into the image domain and by optimizing the distance between the discriminative image and the discriminative text. The algorithmic architecture of the model not only enhances a capability of the model for processing the known class (the capability comes from increasing data from other domains of the same class, which enlarges the range of the image domain that the model can process), but also enables the model to have a capability for processing the unknown class (the capability comes from the fact that the entire architecture design of the model can perceive the feature information and class information of the data, which is helpful in processing inconsistent and abnormal data).

The above is only the embodiments of the present disclosure and not intended to limit the scope of protection of the present disclosure. Any modification, equivalent replacement, improvement, and the like made within the spirit and scope of the present disclosure fall within the protection scope of the present disclosure.

1. A method for data processing, comprising:
encoding a sample in an image set to obtain an encoding result, and mapping the encoding result to obtain feature information of the sample;
generating a first text feature vector based on the feature information and a first descriptive text of the sample, and generating a second text feature vector based on the feature information, a second descriptive text of the sample and a class encoding of the sample;
generating an image encoding of the sample based on the first text feature vector, the second text feature vector and the sample, wherein the image encoding comprises the feature information and class information of the sample; and
adjusting a parameter of a model based on the first text feature vector, the second text feature vector and the image encoding.

2. The method of claim 1, wherein before encoding the sample in the image set, the method further comprises:
constructing a positive prompt and a negative prompt based on a first sample,
combining the positive prompt and the negative prompt to obtain a combination result, and generating a second sample based on the combination result, wherein the second sample comprises at least one of: a sample of a known class or a sample of an unknown class; and
constructing the image set based on the second sample and the first sample.

3. The method of claim 1, wherein the feature information comprises first feature information and second feature information;
generating the first text feature vector based on the feature information and the first descriptive text of the sample comprises:
encoding the first descriptive text of the sample to obtain a first descriptive text encoding;
concatenating the first descriptive text encoding and the first feature information to obtain a first text encoding; and
encoding the first text encoding to obtain the first text feature vector;
generating the second text feature vector based on the feature information, the second descriptive text of the sample and the class encoding of the sample comprises:
encoding the second descriptive text of the sample to obtain a second descriptive text encoding;
concatenating the second descriptive text encoding, the second feature information, and the class encoding of the sample to obtain a second text encoding; and
encoding the second text encoding to obtain the second text feature vector.

4. The method of claim 1, wherein generating the image encoding of the sample based on the first text feature vector, the second text feature vector and the sample comprises:
generating a text encoding corresponding to the sample based on the first text feature vector and the second text feature vector, wherein the text encoding comprises the feature information and the class information of the sample;
upsampling the text encoding to obtain a sampled text encoding, wherein a dimension of the sampled text encoding is the same as a dimension of the sample; and
generating the image encoding of the sample based on the sampled text encoding and the sample.

5. The method of claim 4, wherein generating the image encoding of the sample based on the sampled text encoding and the sample comprises:
adding the sampled text encoding and the sample to obtain an addition result, and mapping the addition result to obtain a mapping result; and
encoding the mapping result to obtain the image encoding of the sample.

6. The method of claim 1, wherein adjusting the parameter of the model based on the first text feature vector, the second text feature vector and the image encoding comprises:
constructing a first loss function based on the first text feature vector and the second text feature vector;
constructing a second loss function based on the second text feature vector and the image encoding; and
updating the parameter of the model based on the first loss function and the second loss function.

7. The method of claim 6, wherein the model comprises: a text encoder, an image encoder and a linear mapping layer, wherein the text encoder is configured to generate the first text feature vector and the second text feature vector, the image encoder is configured to encode the sample, and the linear mapping layer is configured to generate the image encoding of the sample;
updating the parameter of the model based on the first loss function and the second loss function comprises:
constructing a total loss function based on the first loss function and the second loss function; and
keeping a parameter of the text encoder and a parameter of the image encoder unchanged, and updating a parameter of the linear mapping layer based on the total loss function.

8. The method of claim 2, wherein there are a plurality of second samples, and after generating the plurality of second samples based on the combination result, the method further comprises at least one of:
adjusting the positive prompt and the negative prompt; or
removing samples with a quality parameter less than a quality parameter threshold from the plurality of second samples.

9. A method for image classification, comprising:
acquiring an image to be classified; and
classifying the image by a pre-trained model to obtain a classification result, wherein the pre-trained model is obtained according to the method of claim 1.

10. The method of claim 9, wherein classifying the image to be classified by the pre-trained model to obtain the classification result comprises:
performing, through the pre-trained model, the following processing:
encoding the image to be classified to obtain an encoding result and mapping the encoding result to obtain feature information of the image to be classified;
generating a third text feature vector based on the feature information and a third descriptive text of the image to be classified;
generating an image encoding of the image to be classified based on the third text feature vector and the image to be classified, wherein the image encoding comprises the feature information;
generating a plurality of fourth text feature vectors based on the feature information, a fourth descriptive text of the image to be classified and a plurality of class encodings, wherein the plurality of class encodings are obtained by encoding class information of a first class and class information of a second class, the first class is a class of a sample in an image set, and the first class is different from the second class;
determining similarities between the image encoding and the plurality of fourth text feature vectors; and
determining the classification result of the image to be classified based on a fourth text feature vector corresponding to a maximum similarity.

11. An electronic device, comprising:
a memory, configured to store computer-executable instructions;
a processor, configured to execute the computer-executable instructions stored in the memory, to cause the electronic device to:
encode a sample in an image set to obtain an encoding result, and map the encoding result to obtain feature information of the sample;
generate a first text feature vector based on the feature information and a first descriptive text of the sample, and generate a second text feature vector based on the feature information, a second descriptive text of the sample and a class encoding of the sample;
generate an image encoding of the sample based on the first text feature vector, the second text feature vector and the sample, wherein the image encoding comprises the feature information and class information of the sample; and
adjust a parameter of a model based on the first text feature vector, the second text feature vector and the image encoding.

12. The electronic device of claim 11, wherein before encoding the sample in the image set, the processor is configured to execute the computer-executable instructions to cause the electronic device to:
construct a positive prompt and a negative prompt based on a first sample,
combine the positive prompt and the negative prompt to obtain a combination result, and generate a second sample based on the combination result, wherein the second sample comprises at least one of: a sample of a known class or a sample of an unknown class; and
construct the image set based on the second sample and the first sample.

13. The electronic device of claim 11, wherein the feature information comprises first feature information and second feature information, and the processor is configured to execute the computer-executable instructions to cause the electronic device to:
encode the first descriptive text of the sample to obtain a first descriptive text encoding;
concatenate the first descriptive text encoding and the first feature information to obtain a first text encoding;
encode the first text encoding to obtain the first text feature vector;
encode the second descriptive text of the sample to obtain a second descriptive text encoding;
concatenate the second descriptive text encoding, the second feature information, and the class encoding of the sample to obtain a second text encoding; and
encode the second text encoding to obtain the second text feature vector.

14. The electronic device of claim 11, wherein the feature information comprises first feature information and second feature information, and the processor is configured to execute the computer-executable instructions to cause the electronic device to:
generate a text encoding corresponding to the sample based on the first text feature vector and the second text feature vector, wherein the text encoding comprises the feature information and the class information of the sample;
upsample the text encoding to obtain a sampled text encoding, wherein a dimension of the sampled text encoding is the same as a dimension of the sample; and
generate the image encoding of the sample based on the sampled text encoding and the sample.

15. The electronic device of claim 14, wherein the processor is configured to execute the computer-executable instructions to cause the electronic device to:
add the sampled text encoding and the sample to obtain an addition result, and map the addition result to obtain a mapping result; and
encode the mapping result to obtain the image encoding of the sample.

16. The electronic device of claim 11, wherein the processor is configured to execute the computer-executable instructions to cause the electronic device to:
construct a first loss function based on the first text feature vector and the second text feature vector;
construct a second loss function based on the second text feature vector and the image encoding; and
update the parameter of the model based on the first loss function and the second loss function.

17. The electronic device of claim 16, wherein the model comprises: a text encoder, an image encoder and a linear mapping layer, wherein the text encoder is configured to generate the first text feature vector and the second text feature vector, the image encoder is configured to encode the sample, and the linear mapping layer is configured to generate the image encoding of the sample;
the processor is configured to execute the computer-executable instructions to cause the electronic device to:
construct a total loss function based on the first loss function and the second loss function; and
keep a parameter of the text encoder and a parameter of the image encoder unchanged, and update a parameter of the linear mapping layer based on the total loss function.

18. The electronic device of claim 12, wherein there are a plurality of second samples, and the processor is configured to execute the computer-executable instructions to cause the electronic device to perform at least one of:
adjusting the positive prompt and the negative prompt; or
removing samples with a quality parameter less than a quality parameter threshold from the plurality of second samples.

19. An electronic device, comprising:
a memory, configured to store computer-executable instructions;
a processor, configured to execute the computer-executable instructions stored in the memory, to cause the electronic device to:
acquire an image to be classified; and
classify the image by a pre-trained model to obtain a classification result, wherein the pre-trained model is obtained by the electronic device of claim 11.

20. A non-transitory computer-readable storage medium, configured to store a computer program that causes a processor to perform a method for data processing, comprising:
encoding a sample in an image set to obtain an encoding result, and mapping the encoding result to obtain feature information of the sample;
generating a first text feature vector based on the feature information and a first descriptive text of the sample, and generating a second text feature vector based on the feature information, a second descriptive text of the sample and a class encoding of the sample;
generating an image encoding of the sample based on the first text feature vector, the second text feature vector and the sample, wherein the image encoding comprises the feature information and class information of the sample; and
adjusting a parameter of a model based on the first text feature vector, the second text feature vector and the image encoding.
